(19) United States
(12) Patent Application Publication
(10) Pub. No.: US 2014/0036197 A1
(43) Pub. Date: Feb. 6, 2014

(54) Liquid Crystal Module and Liquid Crystal Display Device

(71) Applicant: Kabushiki Kaisha Toshiba, Tokyo (JP)

(72) Inventor: Keitaro Furusho, Fukaya-shi (JP)

(73) Assignee: KABUSHIKI KAISHA TOSHIBA, Tokyo (JP)

(21) Appl. No.: 13/895,560

(22) Filed: May 16, 2013

(30) Foreign Application Priority Data
Jul. 31, 2012 (JP) 2012-170640

(51) Int. Cl. G02F 1/1333

(52) U.S. Cl. CPC G02F 1/133308
USPC 349/58

(57) ABSTRACT

A liquid crystal module includes a liquid crystal cell, support members, a chassis, and joining members. The liquid crystal cell is substantially rectangular in external form. The support members are provided for at least three of four sides of an outer peripheral edge portion of a rear surface of the liquid crystal cell. Each support member extends from near one end portion of the corresponding side to near the other end portion. The support members are bonded or adhered to the outer peripheral portion. The chassis includes a bottom portion and walls. The bottom portion is substantially rectangular in external form. The walls surround the bottom portion. Each joining member is joined to the corresponding support member. Each joining member is joined to the corresponding wall of the chassis from near one end portion of the corresponding wall in its longitudinal direction to near the other end portion.

### CROSS-REFERENCE TO RELATED APPLICATION(S)

The present disclosure claims priority to Japanese Patent Application No. 2012-170640, filed on Jul. 31, 2012, which is incorporated herein by reference in its entirety.

### TECHNICAL FIELD

Embodiments described herein relate generally to a liquid crystal module and a liquid crystal display device.

### BACKGROUND ART

In recent years, flat display devices such as liquid crystal display devices are widely used as image display devices of TV receivers, various types of computer apparatus, etc. because of their advantages of thin shape, light weight, and low power consumption.

For example, a transmissive liquid crystal device includes a liquid crystal cell in which a liquid crystal layer is held between a pair of transparent substrates and a backlight device which is disposed on a rear surface side (here, the back side is a surface opposite to an image display surface) of the liquid crystal cell and guides light to the liquid crystal cell. The backlight device is classified into the direct lighting type in which a light source is disposed under a liquid crystal panel and the edge lighting type (side lighting type) in which a light guide plate is disposed under a liquid crystal panel and light sources are disposed around the light guide. Edge lighting liquid crystal devices are used more widely than direct lighting ones because there are such demands to liquid crystal devices as thickness reduction and size reduction.

On the other hand, for improvement in appearance (external design) and further size reduction, liquid crystal devices are now desired to be reduced in the width of a frame. Here, the frame is a front cover which covers the periphery of the screen of a liquid crystal device. As the frame-shaped front cover is made narrower, the entire size of the liquid crystal device is further decreased and the cost of the components of the front cover is further reduced.

### BRIEF DESCRIPTION OF THE DRAWINGS

FIG. 1 is a perspective view showing an appearance of a liquid crystal device according to an embodiment;

FIG. 2 is a sectional view, taken along a line II-II in FIG. 1, of the liquid crystal device according to the embodiment;

FIG. 3 is a perspective view showing an appearance of a liquid crystal module according to the embodiment;

FIG. 4 is an exploded perspective view showing the schematic configuration of the liquid crystal module according to the embodiment;

FIG. 5 is a perspective view showing a joining relationship between a liquid crystal cell and a back chassis;

FIG. 6 is a perspective view showing an appearance of a liquid crystal cell support member;

FIG. 7 is a perspective view, as viewed from a rear surface side, of the liquid crystal cell to which the liquid crystal cell support members are bonded or adhered;

FIG. 8 is a perspective view showing an appearance of a joining member;

FIG. 9A is an enlarged perspective view showing a second engagement portion of the joining member;

FIG. 9B is an enlarged perspective view showing a first engagement portion of the liquid crystal cell support member;

FIG. 10 is an enlarged perspective view showing a state where the liquid crystal cell support member and the joining member are joined to each other;

FIG. 11 is a sectional view, taken along line XI-XI in FIG. 3, of an upper portion of the liquid crystal module according to the embodiment;

FIG. 12A is a perspective view showing a joining member of another example of the embodiment; and

FIG. 12B a perspective view showing a liquid crystal cell support member of the other example of the embodiment.

### DETAILED DESCRIPTION

According to one embodiment, a liquid crystal module includes a flat-plate-shaped transmissive liquid crystal cell, at least three liquid crystal cell support members, a chassis, and at least three joining members. The liquid crystal cell is substantially rectangular in external form. The liquid crystal cell support members are provided for at least three of four sides of an outer peripheral edge portion of a rear surface of the liquid crystal cell. The rear surface is opposite to a video display surface of the liquid crystal cell. Each liquid crystal cell support member extends from near one end portion of the corresponding side to near the other end portion of the corresponding side. The liquid crystal cell support members are bonded or adhered to the outer peripheral portion. The chassis includes a bottom portion and walls. The bottom portion is substantially rectangular in external form. The walls of the chassis surround the bottom portion of the chassis. Each joining member is joined to the corresponding liquid crystal cell support member. Each joining member is joined to the corresponding wall of the chassis from near one end portion of the corresponding wall in a longitudinal direction of the corresponding wall to near the other end portion of the corresponding wall.

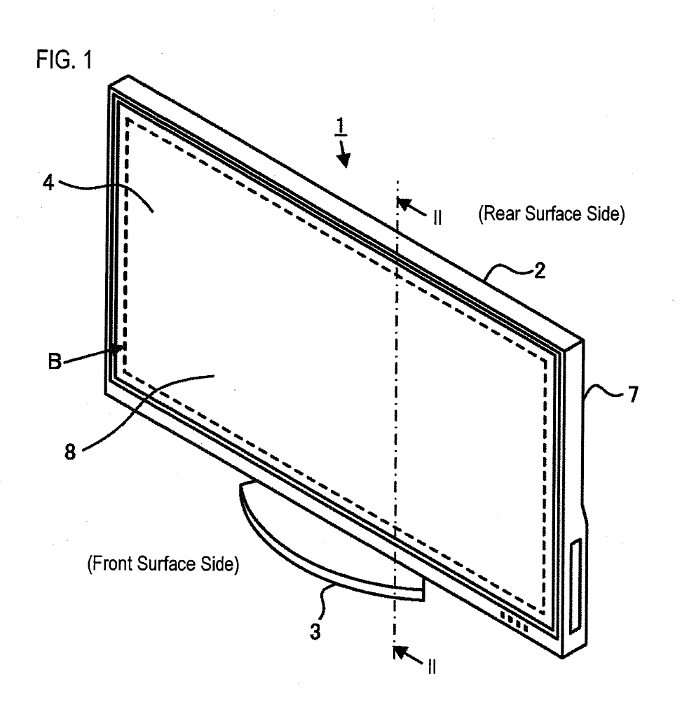

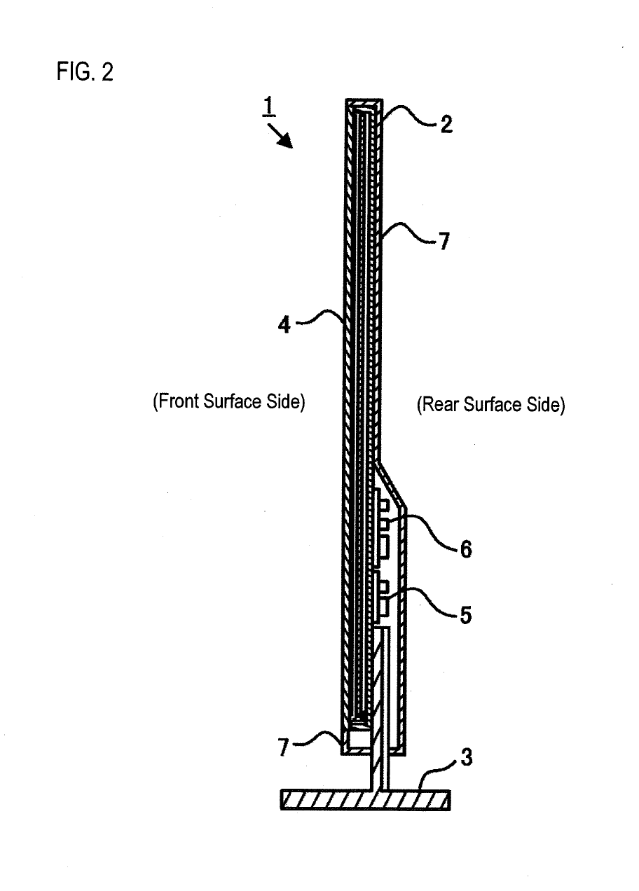

Embodiments will be hereinafter described in detail with reference to the accompanying drawings. FIG. 1 is a perspective view showing an appearance of a liquid crystal device 1 according to one embodiment. FIG. 2 is a sectional view, taken along a line II-II in FIG. 1, of the liquid crystal device 1 according to the embodiment. The liquid crystal device 1 includes a main body 2 and a stand 3 that is disposed under the main body 2 to support the main body 2. A liquid crystal module 4 is disposed in the main body 2 on the front surface side thereof. A circuit board 5 configured to drive the liquid crystal module 4 and a power circuit board 6 are disposed on the rear surface side of the liquid crystal module 4.

An outer surface of the main body 2 is surrounded by a cover 7 configured to cover a rear surface, an upper surface, a bottom surface, both side surfaces, and a part of a lower portion of a front surface of the main body 2. A screen 8 has a video display area (indicated by a broken line B in FIG. 1) on a video display surface side of the liquid crystal module 4.

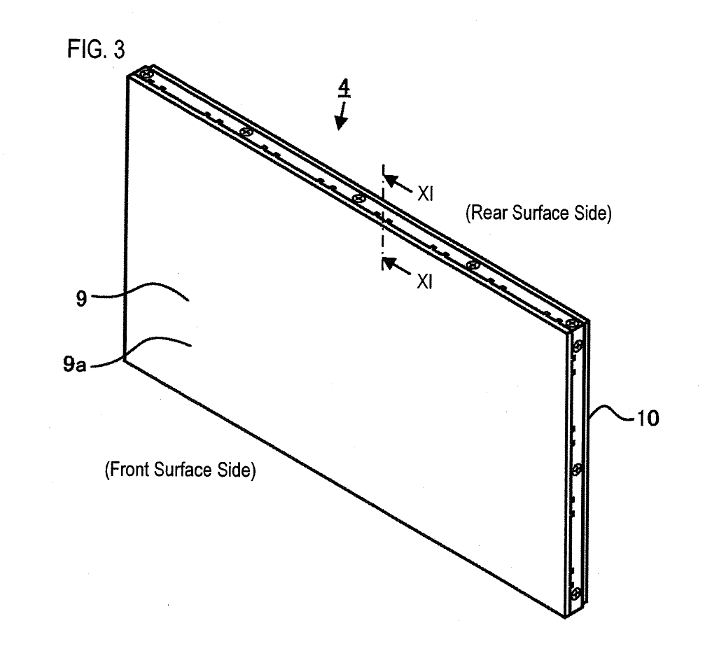

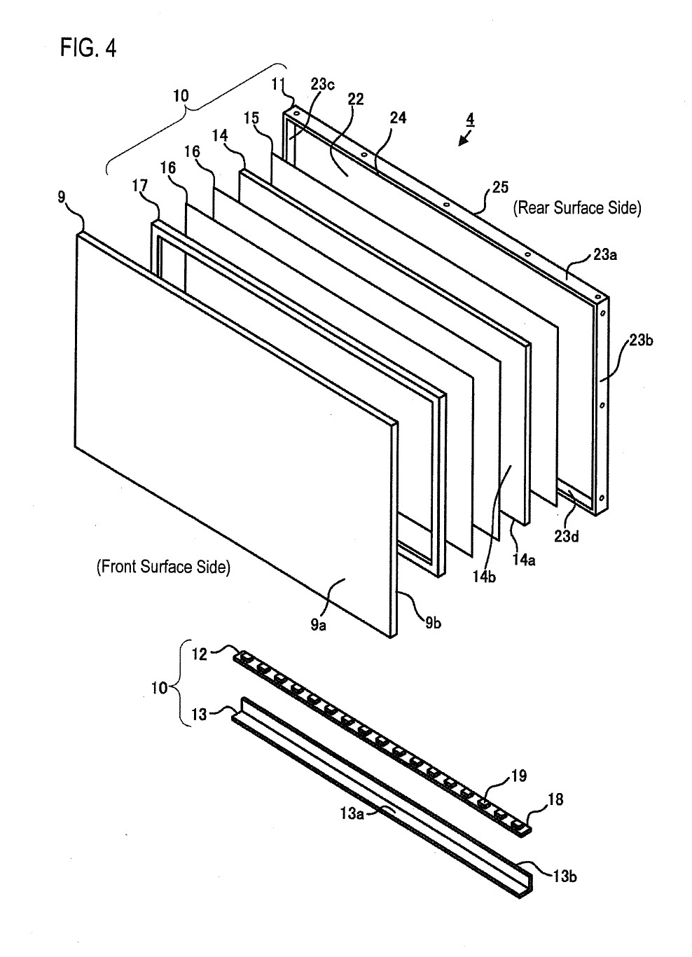

FIG. 3 is a perspective view showing an appearance of the liquid crystal module 4 according to the embodiment. FIG. 4 is an exploded perspective view showing the schematic configuration of the liquid crystal module 4 according to the embodiment. The liquid crystal module 4 includes a liquid crystal cell 9 and a backlight device 10.

The liquid crystal cell 9 is a flat-plate-shaped transmissive liquid crystal panel which is generally rectangular in external form. The liquid crystal cell 9 has a flat structure in which a space between at least two substrates (not shown) made of glass or the like is filled with a liquid crystal substance. Usually, an interval between the substrates is a few or several micrometers. Polarizing plates (not shown) are respectively disposed on an outside of the substrate of a video display surface 9a and on an outside of the substrate of a rear surface 9b which is opposite to the video display surface 9a.

The backlight device 10 includes a back chassis 11 which is a main chassis of the backlight device 10, a light source device 12, a heat radiation plate 13, a light guide plate 14, a reflection sheet 15, optical sheets 16 such as a diffuser sheet, a prism sheet, etc., an intermediate pressing frame 17, etc.

The back chassis 11 is a member manufactured by sheet metal working or resin molding. The back chassis 11 has a generally rectangular bottom portion 22 and four side walls 23a to 23d which surround the bottom portion 22. The four side walls 23a to 23d may be disposed at parts of peripheral portions of the four sides of the bottom portion 22, respectively. The back chassis 11 has an opening portion 24 on the front surface side thereof, and screw holes and studs (not shown), on a rear surface 25 side, for attachment of reinforcement ribs and various components. The circuit board 5 for driving the liquid crystal cell 9 and the light source device 10 and the power circuit board 6 are attached to the back chassis 11 using those screw holes and studs.

The reflection sheet 15, the light guide plate 14, and the optical sheets 16 are disposed on the opening portion 24 side (front surface side) of the back chassis 11, and assembled to the back chassis 11 using the intermediate pressing frame 17.

The lower wall 23d on the front surface side of the back chassis 11 is provided with the heat radiation plate 13 and the light source device 12. If the wall 23d is not provided, a rear surface 13b of the heat radiation plate 13 is fixed to the bottom portion 22. The heat radiation plate 13 is formed by extrusion molding, for example, and is made of aluminum, for example. The heat radiation plate 13 has functions of radiating heat generated by the light source device 12 and positioning the light source device 12. The heat radiation plate 13 is substantially L-shaped in section. The light source device 12 is fixed to an upper surface 13a on a bottom surface side of the substantial L shape by an adhesive agent, for example. The heat radiation plate 13 is fixed to the lower portion, on the front surface side, of the back chassis 11. A part of the heat generated by the light source device 12 is released to the back chassis 11.

The light source device 12 is a circuit board in which plural light emitting elements 19 such as LEDs (light emitting diodes) are mounted on a light emitting element wiring board 18 in line. The light emitting element wiring board 18 is a flexible wiring board or a rigid board such as a glass epoxy board or an aluminum board. For example, the light emitting elements 19 are LEDs each having an external size of about 6 mm×3 mm. The plural LEDs may be mounted on the light emitting element wiring board 18 at intervals of several millimeters to several centimeters. A connector (not shown) configured to supply drive power to the light emitting elements 19 is provided at an end portion of the light emitting element wiring board 18.

The light guide plate 14 is a plate-like member which is substantially rectangular in external form, and is approximately the same as or somewhat smaller than the liquid crystal cell 11 in external size. The light guide plate 14 is an acrylic plate or a polycarbonate plate. The light guide plate 14 has a light incidence surface 14a on which light emitted from the light source device 12 is incident and a light exit surface 14b from which the light being incident on the light incidence surface 14a is output. The light incidence surface 14a is disposed over and near the light emitting elements 19. The light guide plate 14 is configured so that the light emitted from the light source device 12 enters the light guide plate 14 through the light incidence surface 14a, is reflected repeatedly inside the light guide plate, and is finally output from the light guide plate through the entire light exit surface 14b which is opposed to the rear surface 9b of the liquid crystal cell 9. The light guide plate 14 applies the light from the light source device 12 to the rear surface 9b of the liquid crystal cell 9.

The reflection sheet 15 is disposed between the light guide plate 14 and the back chassis 11. The reflection sheet 15 is an optical member configured to reflect light radiated from the light guide plate toward the back chassis 11 side to return the light to the light guide plate 14, for effective use of the light. Also, there may be a case where the surface, being opposed to the reflection sheet 15, of the light guide plate 14 may be coated with a reflective material.

The optical sheets 16 are disposed on the light exit surface 14b side of the light guide plate 14. The optical sheets 16 are optical members for illuminating the rear surface of the liquid crystal cell 9 uniformly by diffusing and adjusting propagating directions of the light, which is output from the light guide plate 14.

The intermediate pressing frame 17 is a frame-shaped member formed by the resin molding or the aluminum extrusion molding. The intermediate pressing frame 17 positions the reflection sheet 15, the light guide plate 14, and the optical sheets 16 with respect to the front surface side of the back chassis 11 and prevents the reflection sheet 15, the light guide plate 14, and the optical sheets 16 from coming off the back chassis 11. This embodiment employs the edge lighting type backlight device 10. However, a direct lighting type backlight device may be used in this embodiment.

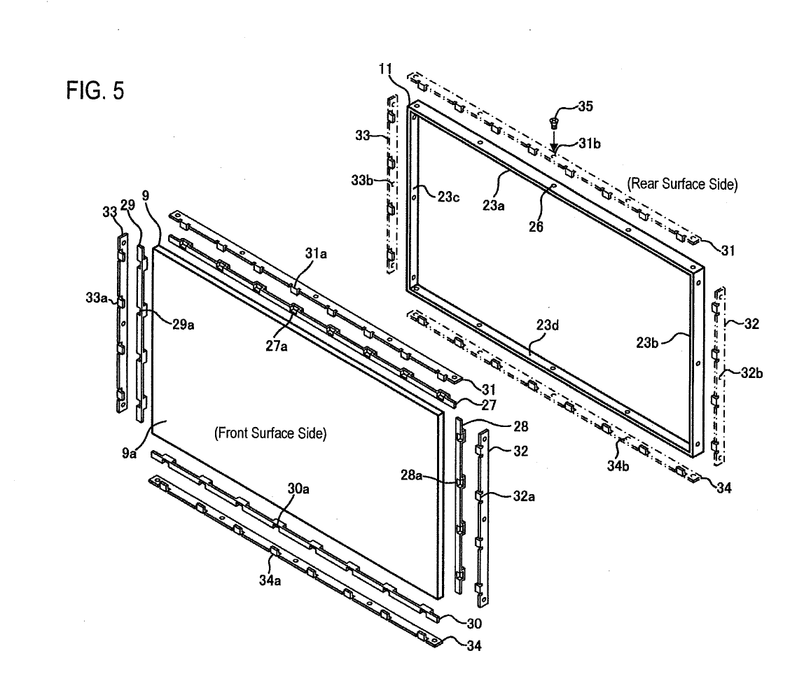

Next, description will be given on how the liquid crystal cell 9 is positioned and how the liquid crystal cell 9 and the back chassis 11 are joined to each other. FIG. 5 is a perspective view showing a joining relationship between the liquid crystal cell 9 and the back chassis 11. Liquid crystal cell support members 27 to 30 are bonded or adhered to an outer peripheral edge portion of the rear surface 9b of the liquid crystal cell 9. Each of the liquid crystal cell support members 27 to 30 has plural first engagement portions 27a, 28a, 29a, or 30a.

Each of joining members 31 to 34 has plural second engagement portions 31a, 32a, 33a, or 34a. The joining members 31 to 34 are joined to the respective liquid crystal cell support members 27 to 30 by engaging the second engagement portions 31a to 34a of the joining members 31 to 34 with the first engagement portions 27a to 30a of the liquid crystal cell support members 27 to 30.

Each of the joining members 31 to 34 has plural through-holes 31b, 32b, 33b, or 34b. Each of the walls 23a to 23d of the back chassis 11 has plural screw holes 26. The joining members 31 to 34 are joined to the respective walls 23a to 23d by fitting the back chassis 11, in which the light source device 12, the radiation plate 13, the light guide plate 14, the reflection sheet 15, the optical sheets 16, etc. have already been assembled, to an inside of a frame body formed of the joining members 31 to 34 and by screwing screws 35 into the screw holes 26 through the through-holes 31b to 34b.

The liquid crystal module 4 shown in FIG. 3 is formed by joining the back chassis 11 to the liquid crystal cell 9 in the above-described manner. As shown in FIG. 3, when viewed from the front surface side, the liquid crystal module 4 is approximately the same in external form as the liquid crystal cell 9.

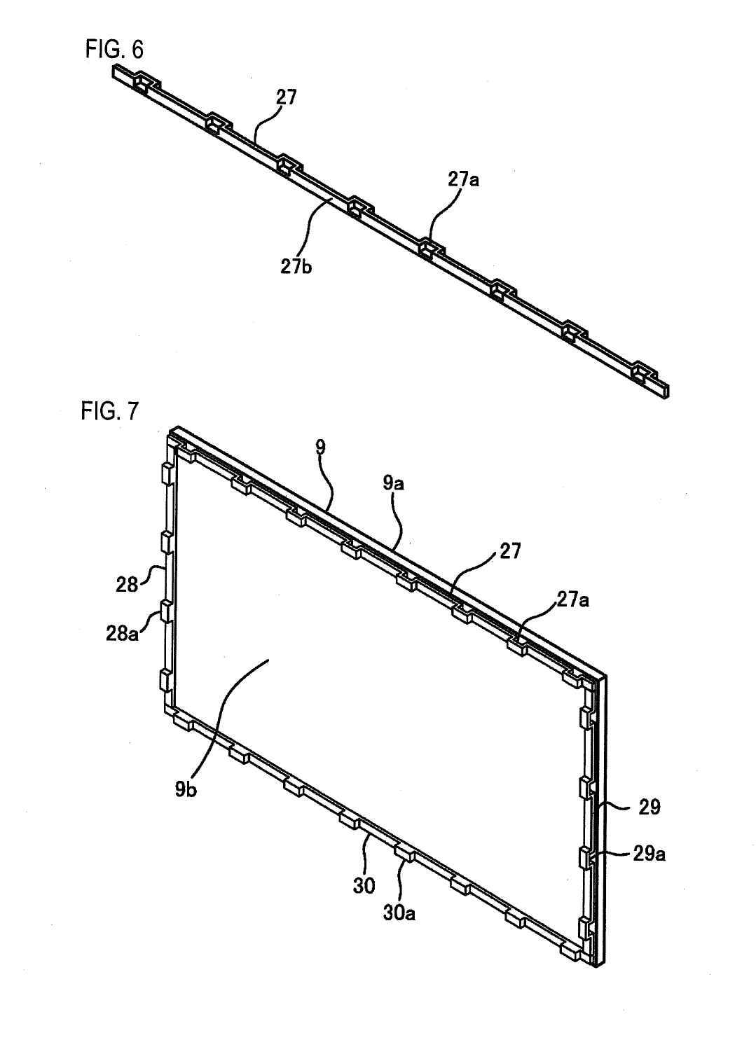

FIG. 6 is a perspective view showing an appearance of the liquid crystal cell support member 27. FIG. 7 is a perspective view, as viewed from the rear surface 9b side, of the liquid crystal cell 9 to which the liquid crystal cell support members 27 to 30 are bonded or adhered. The liquid crystal cell support member 27 is shaped like a long and narrow rod and is formed by the resin molding. For each of at least three of the four sides of the outer peripheral edge portion of the rear surface 9b of the liquid crystal cell 9, the liquid crystal cell support member is provided so as to extend from near one end portion of each side to near the other end portion of each side and is bonded or adhered to the outer peripheral edge portion. For example, the liquid crystal cell support member 27 is provided so as to extend from near one end portion of the upper side of the rear surface 9b of the liquid crystal cell 9 to near the other end portion thereof.

Where the liquid crystal cell support members are provided for three of the four sides, the one side corresponding to the bottom portion is not provided with the liquid crystal cell support member 30 and, instead, a bezel configured to support the liquid crystal cell 9 is provided separately only for the side corresponding to the bottom portion. For example, this bezel is a member which sandwiches and supports a portion, extending along the side of the bottom portion of the front surface 9a of the liquid crystal cell 9. In the example of FIG. 7, the liquid crystal cell support members 27 to 30 are provided for the four sides. Specifically, the liquid crystal cell support members 27 and 30 are bonded or adhered to the long sides of the rear surface 9b, and the liquid crystal cell support members 28 and 29 are bonded or adhered to the short sides of the rear surface 9b.

One surface of the liquid crystal cell support member 27 is a bonding surface 27b which is bonded or adhered to the outer peripheral edge portion of the rear surface 9b of the liquid crystal cell 9. As for the bonding or adhering, a proper bonding agent, adhesive agent, bonding tape, or adhesive tape may be selected according to the surface material of the liquid crystal cell 9, the surface state of the liquid crystal cell 9, and the material of the liquid crystal cell support member 27 and the surface state of the bonding surface 27b thereof. Either the whole or part of the bonding surface 27b may be bonded or adhered. Whether the whole or part of the bonding surface 27b is bonded or adhered may be determined appropriately.

The liquid crystal cell support member 27 is formed with the first engagement portions 27a at approximately regular intervals. When the liquid crystal cell support member 27 is bonded or adhered to the outer peripheral edge portion of the long side of the liquid crystal cell 9, the first engagement portions 27a form recess portions which are open to the outside of the liquid crystal cell 9. In the example of FIG. 6, eight first engagement portions 27a are formed. Likewise, the liquid crystal cell support member 30 is formed with eight first engagement portions 30a, and each of the short-side liquid crystal cell support members 28 and 29 is formed with four first engagement portions 28a or 29a.

The liquid crystal cell support member 27 extends fully along the long side of the liquid crystal cell 9. Likewise, the liquid crystal cell support member 30 extends fully along the long side of the liquid crystal cell 9, and each of the liquid crystal cell support members 28 and 29 extends fully along the short edge of the liquid crystal cell 9. The liquid crystal cell support members 27 to 30 are members that extend fully along either the long side or the short side of the liquid crystal cell 9. Thereby, it is possible to weaken non-uniform stress acting on a peripheral portion of the liquid crystal cell 9, to increase the strength of support of the liquid crystal cell 9, and to strengthen the outer peripheral edge portion of the liquid crystal cell 9.

For example, if the liquid crystal cell support member 27 were to be divided into eight parts that correspond to the respective first engagement portions 27a and the eight parts were to be bonded to the outer peripheral edge portion of the liquid crystal cell 9, local stress might be generated around each first engagement portion 27a to cause non-uniform stress acting on the long side of the liquid crystal cell 9, resulting in luminance unevenness in a peripheral area of the display screen, that is, degradation of a display image quality. The liquid crystal cell support member 27 which extends fully along the corresponding side can reduce local stress and/or non-uniform stress and prevent occurrence of the luminance unevenness.

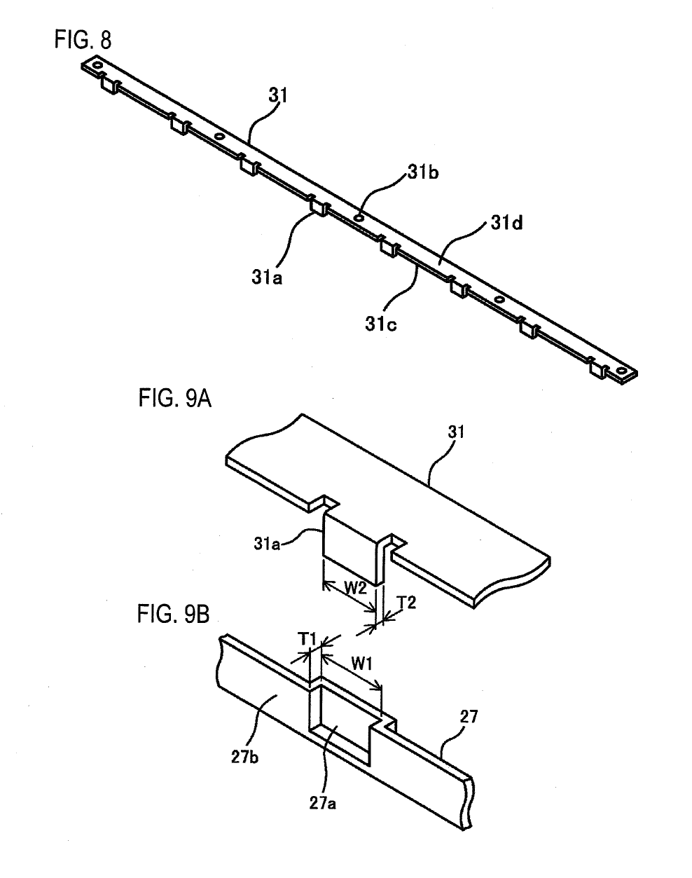

FIG. 8 is a perspective view showing an appearance of the joining member 31. The joining member 31 is shaped like a long and narrow rod and is formed by the sheet metal working or the resin molding. The joining members are joined to the respective liquid crystal cell support members, and are also joined to the respective walls of the back chassis 11 from near one end portions of the respective wall portions in a longitudinal direction thereof to near the other end portion of the respective wall portions. Like the liquid crystal cell support members, at least three joining members are provided. The joining member 31 has the plural second engagement portions 31a which project toward a direction of a joining surface 31c of the joining member 31. The second engagement portions 31a are arranged at approximately regular intervals. The intervals between the second engagement portions 31a are equal to those between the first engagement portions 27a of the liquid crystal cell support member 27. The joining member 31 is joined to the liquid crystal cell support member 27 by engaging the second engagement portions 31a with the respective first engagement portions 27a. In the example of FIG. 8, eight second engagement portions 31a are provided.

Likewise, the joining member 34 is formed with eight second engagement portions 34a, and each of the short-side joining members 32 and 33 is formed with four second engagement portions 32a or 33a. The joining member 34 is joined to the liquid crystal cell support member 30 by engaging the second engagement portions 34a with the respective first engagement portions 30a. The joining member 32 is joined to the liquid crystal cell support member 28 by engaging the second engagement portions 32a with the respective first engagement portions 28a. The joining member 33 is joined to the liquid crystal cell support member 29 by engaging the second engagement portions 33a with the respective first engagement portions 29a.

The plural (five in the example of FIG. 8) through-holes 31b are formed to penetrate the joining member 31. Likewise, five through-holes 34b are formed to penetrate the joining member 34, and three through-holes 32b or 33b are formed to penetrate each of the joining members 32 and 33. The through-holes 31b are used for joining the joining member 35 to the back chassis 11 with screws 35.

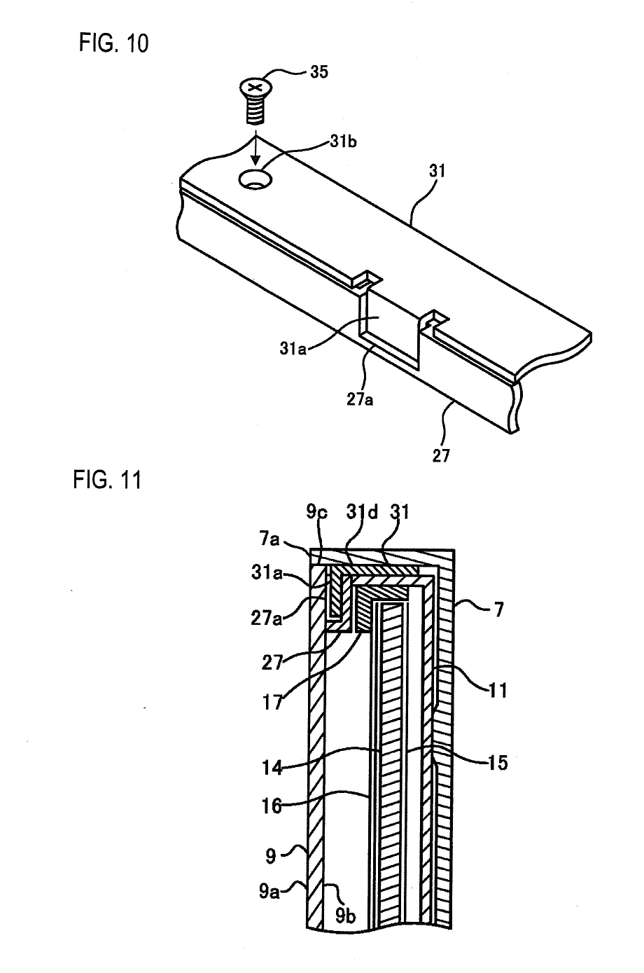

FIG. 9A is an enlarged perspective view showing the second engagement portion 31a of the joining member 31. FIG. 9B is an enlarged perspective view showing the first engagement portion 27a of the liquid crystal cell support member 27. FIG. 10 is an enlarged perspective view showing a state where the liquid crystal cell support member 27 and the joining member 31 are joined to each other. A width W1 of the first engagement portion 27a is greater than a width W2 of the second engagement portion 31a. A depth T1 of the first engagement portion 27a is greater than a thickness T2 of the second engagement portion 31a.

As shown in FIG. 10, the screws 35 are screwed into the screw holes 26 of the wall 23a of the back chassis 11 through the through-holes 31b in a state where the second engagement portions 31a are engaged with the respective first engagement portions 27a. Thereby, the second engagement portions 31a are brought in a state where the second engagement portions 31a are not disengaged from the respective first engagement portions 27a. In this manner, the liquid crystal cell 9 is joined to the back chassis 11.

FIG. 11 is a sectional view, taken along line XI-XI in FIG. 3, of an upper portion of the liquid crystal module 4. The liquid crystal cell support member 27 is bonded or adhered to the outer peripheral edge portion of the rear surface 9b of the liquid crystal cell 9. The second engagement portions 31a of the joining member 31 are engaged with the respective first engagement portions 27a of the liquid crystal cell support member 27. The reflection sheet 15, the light guide plate 14, and the optical sheets 16 are assembled to the back chassis 11 and positioned by the intermediate pressing frame 17. The joining member 31 is fixed to the back chassis 11 with the screws.

In an example of FIG. 11, an upper peripheral surface 9c of the liquid crystal cell 9 is approximately flush with (i.e., approximately at the same height as) an outer surface 31d of the joining member 31. Alternatively, the outer surface 31d may be located at a position that is higher than the upper surface 9c by 0 mm to several mm (less than 20 mm). The cover 7 of the main body 2 is fixed to the back chassis 11 so as to be in contact with the outer surface 31d of the joining member 31. A front edge surface 7a of the cover 7 is approximately flush with the display surface 9a of the liquid crystal cell 9.

When the above-configured liquid crystal display device 1 is viewed from the front surface side, only the front edge surface 7a of the cover 7 is seen around the liquid crystal cell 9. The frame is thus narrowed. Only the lower portion of the liquid crystal cell 9 may be provided with the frame formed of the cover 7. Since the cover 7 is usually formed by the resin molding or the sheet metal working, the front edge surface 7a of the cover 7 can be made thin.

As described above, the liquid crystal cell support members 27 to 30 are bonded or adhered to the outer peripheral portion of the rear surface 9b of the liquid crystal cell 9 in such a manner that each of the liquid crystal cell support members 27 to 30 extends from near one end portion of the corresponding side of the rear surface 9b to near the other end portion of the corresponding side of the rear surface 9b. The liquid crystal cell support members 27 to 30 are joined to the respective joining members 31 to 34 which are joined to the back chassis 11. As a result, the external form of the liquid crystal module 4 can be made approximately the same as that of the liquid crystal cell 9. The frame can be narrowed by thinning the front edge surface 7a of the cover 7. Also, the use of the liquid crystal cell support members 27 to 30 each of which extends fully along the corresponding side of the outer peripheral edge portion makes it possible to weaken local stress or non-uniform stress even if the liquid crystal cell support members 27 to 30 are bonded or adhered to the liquid crystal cell 9. Luminance unevenness can thus be prevented.

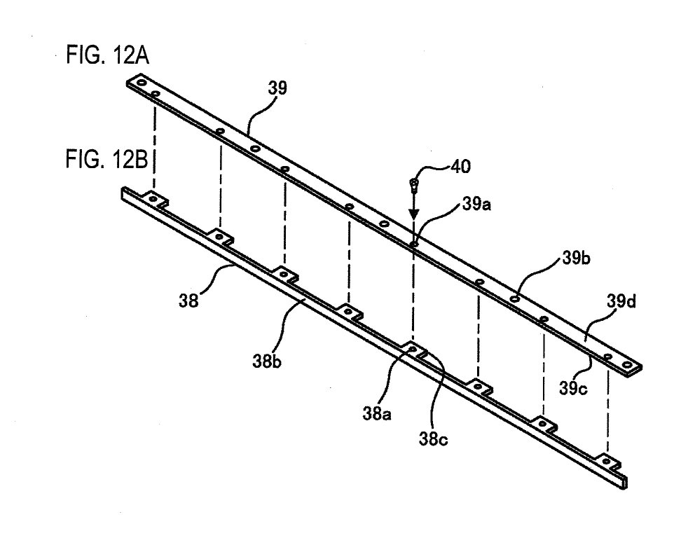

FIG. 12A shows a joining member 39 according to another example of the embodiment. FIG. 12 B shows a liquid crystal cell support member 38 according to the other example of the embodiment. The joining member 39 is joined to the liquid crystal cell support member 38 with screws 40 rather than by fitting.

The liquid crystal cell support member 38 has plural (eight in the example of FIG. 12B) screw holes 38a. Joining support portions 38c are formed so as to project approximately perpendicularly to a bonding surface 38b to be bonded to the liquid crystal cell 9. The screw holes 38a are formed at the centers of the joining support portions 38c, respectively.

Plural (eight in the example of FIG. 12A) through-holes 39a and plural through-holes 39b are formed to penetrate the joining member 39. The through-holes 39a serve for joining the joining member 39 to the liquid crystal cell support member 38. The joining member 39 is joined to the liquid crystal cell support member 38 by screwing screws 40 into the screw holes 38a of the liquid crystal cell support member 38 through the through-holes 39a, respectively. The through-holes 39a have the same function as the through-holes 31b shown in FIG. 8. As described above, the joining member 39 may be joined to the liquid crystal cell support member 38 with the screws 40.

The invention is not limited to the above embodiments themselves. In the practice stage, the invention may be embodied in such a manner that constituent elements are modified without departing from the spirit and scope of the invention. And, various inventive concepts may be conceived by properly combining plural constituent elements described in the embodiments. For example, several ones of the constituent elements of the embodiments may be omitted. Furthermore, constituent elements of different embodiments may be combined as appropriately.

What is claimed is:

1. A liquid crystal module comprising:
a flat-plate-shaped transmissive liquid crystal cell being substantially rectangular in external form;
at least three liquid crystal cell support members provided for at least three of four sides of an outer peripheral edge portion of a rear surface of the liquid crystal cell, the rear surface being opposite to a video display surface of the liquid crystal cell, each liquid crystal cell support member extending from near one end portion of the corresponding side to near the other end portion of the corresponding side, the liquid crystal cell support members being bonded or adhered to the outer peripheral portion;
a chassis including
a bottom portion being substantially rectangular in external form, and
walls surrounding the bottom portion; and
at least three joining members each of which is joined to the corresponding liquid crystal cell support member, each joining member being joined to the corresponding wall of the chassis from near one end portion of the corresponding wall in a longitudinal direction of the corresponding wall to near the other end portion of the corresponding wall.

2. The module of claim 1, wherein
each liquid crystal cell support member includes a plurality of first engagement portions,
each joining member includes plural second engagement portions, and
each joining member is joined to the corresponding liquid crystal cell support member by engagement between the second engagement portions of each joining member and the first engagement portions of the corresponding liquid crystal cell support member.

3. The module of claim 1, wherein
each liquid crystal cell support member includes a bonding surface, and
an entire or part of each bonding surface is bonded or adhered to the outer peripheral edge portion.

4. The module of claim 2, wherein the first engagement portions includes recess portions configured to be open to an outside direction of the liquid crystal cell when the liquid crystal cell support members are bonded or adhered to the outer peripheral edge portion.

5. The module of claim 1, wherein
each joining member is formed with a plurality of through-holes, and
each wall of the chassis is formed with a plurality of screw holes.

6. The module of claim 2, wherein
each joining member is formed with a plurality of through-holes, and
each wall of the chassis is formed with a plurality of screw holes.

7. The module of claim 1, wherein
each liquid crystal cell support member is formed with a plurality of screw holes,
each joining members is formed with plural through-holes, and
each joining member is screwed to the corresponding liquid crystal cell support member.

8. A liquid crystal display device comprising:
a flat-plate-shaped transmissive liquid crystal cell being substantially rectangular in external form;
at least three liquid crystal cell support members provided for at least three of four sides of an outer peripheral edge portion of a rear surface of the liquid crystal cell, the rear surface being opposite to a video display surface of the liquid crystal cell, each liquid crystal cell support member extending from near one end portion of the corresponding side to near the other end portion of the corresponding side, the liquid crystal cell support members being bonded or adhered to the outer peripheral portion;
a chassis including
a bottom portion being substantially rectangular in external form, and
walls surrounding the bottom portion;
at least three joining members each of which is joined to the corresponding liquid crystal cell support member, each joining member being joined to the corresponding wall of the chassis from near one end portion of the corresponding wall in a longitudinal direction of the corresponding wall to near the other end portion of the corresponding wall; and
an electric circuit board configured to drive the liquid crystal cell.
